(19) United States
(12) Patent Application Publication
(10) Pub. No.: US 2023/0220676 A1
(43) Pub. Date: Jul. 13, 2023

(54) PORTABLE RAMP

(71) Applicants: SUMITOMO RUBBER INDUSTRIES, LTD., Kobe-shi, Hyogo (JP); Toray Industries, Inc., Tokyo (JP)

(72) Inventors: Masayuki Matsushita, Kobe-shi, Hyogo (JP); Junichiro Hoshikawa, Kobe-shi, Hyogo (JP); Hiromi Taniguchi, Nagoya-shi, Aichi (JP); Nobuo Asahara, Nagoya-shi, Aichi (JP); Yohei Noguchi, Nagoya-shi, Aichi (JP); Akira Tanaka, Nagoya-shi, Aichi (JP)

(21) Appl. No.: 18/010,831

(22) PCT Filed: Jun. 11, 2021
(86) PCT No.: PCT/JP2021/022378

§ 371 Date: Dec. 16, 2022

(30) Foreign Application Priority Data
Jun. 24, 2020 (JP) 2020-108882

(51) Int. Cl. E04F 11/00

(52) U.S. Cl. CPC E04F 11/002; E04F 2011/007; A61G 2220/12; A61G 3/061

(57) ABSTRACT

A ramp includes a plate member. The ramp is formed from a carbon fiber-reinforced resin having a longitudinal elastic modulus in the bridging direction of 50+ GPa, and a connecting section that connects the plate member which plate member can be divided into two in a plane perpendicular to the plate member and parallel to the bridging direction. A reinforcement part forms a plurality of hollow segments arranged single file along the bridging direction of the plate member. The cross section shape perpendicular to the direction of extension of the hollow segments is trapezoidal, the height of the trapezoid is 10 to 50 mm, the base angles are 45° to 90°, the width of the plane that contacts the trapezoidal plate member is 100 to 10 mm, and derailment preventing walls connect to portions of plate member side end faces and hollow segment side end faces.

### TECHNICAL FIELD

This disclosure relates to a ramp used by being placed over a step between objects, the ramp being excellent in lightness, load bearing capacity and durability, and specifically relates to a portable ramp capable of making a wheelchair user board/exit a train in safety.

### BACKGROUND

Elevators and escalators are installed as barrier-free measures in public facilities while stairs are provided with ramps for bypass routes so that wheelchairs can travel easily. However, many steps still exist inside and outside buildings such as public facilities. Such a step may be difficult for wheelchair users and elderly people to get over although healthy people can do it easily.

Regardless of advanced barrier-free society infrastructure, many uncontrolled steps exist so that it may be difficult for wheelchairs to get over barriers such as steps between sidewalk/bus doorway and road, grooves on road, grooves or steps between train doorway and platform or the like.

Such many steps exist even inside and outside personal houses of wheelchair users or elderly people, in addition to public spaces such as transportation means.

There is a recently developed portable ramp which can be set as needed when a wheelchair travels from a platform into a train or from a train doorway onto a platform or when a wheelchair travels from a road into a bus or from a bus doorway onto a road. A plank is placed to make a ramp over the step between the platform/road and the train/bus to support the wheelchair.

Because these ramps are preferably light enough to be carried about easily, they are usually made of resin or fiber-reinforced plastics excellent in lightness and load bearing capacity, rather than metal or wood, as disclosed in JP 2011-217963 A and JP 2013-162818 A.

Because the ramp for wheelchairs is a plank tool on which a wheelchair taking on a care-receiver travels by support of caregivers, the ramp should not be steeply placed over the step. If there is a great difference of height between objects, the ramp should be long to the extent allowed by strength/rigidity for safety and lightness for easy handling.

JP '963 discloses a ramp for an electric train used between a doorway of a train and a platform comprising: a plate-like ramp body having a length in which one end side is placed on the doorway and the other end side is placed on the platform, and has a width allowing the wheelchair to pass therethrough; a hook member having a hanging piece which is fixed to an edge part on one end side of the ramp body and is capable of being engaged with a step part provided in the entrance and exit by bending downward at a tip part of a base piece extending in a direction away from the ramp body; and a flap which is connected to the hook member to be swingable about an axis along the width direction of the ramp body and which extends in a direction away from the base piece, wherein the ramp body is made of fiber-reinforced resin so that the wheelchair user can travel easily between the platform and the train on the ramp.

However, JP '963 fails to suggest any improvement about achieving both weight saving and load bearing capacity while disclosing only that the ramp body is made of fiber-reinforced resin.

JP '818 discloses a portable ramp including at least two pieces of plywood for which plate materials made of fiber reinforced plastic (FRP) are bonded to both front and back surfaces of a square core material composed of a foamable resin, wherein the pieces of plywood have tapered structures 4 and 5 for dissolving the level difference of the pieces of plywood themselves at respective upper and lower ends in a passing direction and have a structure for which an outer side face to the passing direction is fitted by a frame member 9, two or more pieces of plywood are arranged side by side with respect to the passing direction, opposed side faces of the pieces of plywood are connected by a sheet material 6, and the pieces of plywood are made foldable so that a portable ramp which is light in weight and easy to carry can be easily manufactured at a low cost in an optimum size with excellent workability, is excellent in a fixing performance, is not easily broken by a high impact resistant performance of a ramp edge part and a derailment preventing wall, and has an excellent repair performance. The ramp of plywood is made by bonding carbon fiber-reinforced plastic to the top and bottom faces of core material made of foamable resin such as rigid urethane, polypropylene and acrylic.

However, the plywood disclosed in JP '818 has a laminate structure of foamable resin of which top and bottom faces are firmly bonded to carbon fiber-reinforced plastic so that production cost is expensive because of many processes in manufacturing the laminate structure. Further, the laminate structure capable of improving rigidity cannot have lightweight advantage because of weight of the foamable body.

JP 2003-230600 A discloses a portable ramp used to be stretched across the stepped part between matters and comprising a plurality of plate materials comprising a fiber reinforced plastic, the derailment preventing wall having predetermined height (h) and thickness (t) is arranged on the upper surfaces of the plate material ends positioned on both left and right sides of the portable ramp, wherein the surface pressure resistance (f) is controlled within a predetermined range so that the derailment preventing wall can be made hard to be broken even if wheels ride on the derailment preventing wall while the portable ramp is lightweight and capable of being easily carried. JP '600 discloses a preferable configuration in which reinforcing fibers wound on a surface of core material made of hard foam polyurethane or the like and set to a mold into which matrix agent is poured to integrally form a plate member and the derailment preventing wall.

Although the structure disclosed in JP '600 can improve rigidity by employing laminate structure, it cannot have lightweight advantage because of weight of the foamable body.

JP 2014-103983 A discloses a portable ramp comprises a tabular ramp body whose top face is a face on which a wheel chair travels, wherein the ramp body comprises a tabular core composed of corrugated cardboard material, and a reinforcement layer composed of fiber-reinforced resin material stuck to at least the top face and bottom face of the tabular core to further reduce weight and reduce the burden on the user, compared to when polyurethane foam is used as a plate-like core, while securing the necessary rigidity.

However, the reinforcement layer structure disclosed in JP '983 composed of fiber-reinforced resin material stuck to at least the top face and bottom face of the tabular core has to be manufactured in many processes of laminate structure production by spending expensive production cost.

JP 2002-87164 A discloses a ramp device capable of access a wheelchair or the like, wherein the floor member forming the ramp is divided into a plurality of parts in the direction crossing the direction of expansion of the ramp while engaged parts engageable with each other are integrally formed with the end faces of the floor member opposed to each other so that adjacent floor members being vertically engaged to receive a load on a ramp can perform operation at the time of deployment and storage of a ramp without lowering rigidity of the floor member while it is not necessary to reinforce the floor member by additional members.

However, in JP '164, the derailment preventing walls provided at both sides and fixed to floor members on the ramp by weld or screws are manufactured in many processes by spending expensive production cost. Further, it is necessary to use a plurality of ramps having lengths corresponding to different travelling distances because predetermined lengths of side rails as a derailment preventing wall are fixed by weld or screws so that installation burden becomes heavy without sufficient flexibility.

JP 2004-60287 A discloses a ramp in which a left ramp plate and a right ramp plate are arranged parallel to each other at an interval corresponding to a vehicle width of a wheelchair or the like on a road surface on an upper stage and a road surface on a lower stage in a step, wherein an outer member and an inner member telescopically inserted into the outer member are provided, the inner member is housed in the outer member, and a mounting member is provided on the outer member so that the left ramp plate can be mounted on the right ramp plate to be opposed to each other, and the inner member is made of an aluminum alloy extruded shape having a hollow part. According to the ramp disclosed in JP '287, the left ramp plate is mounted on the right ramp plate so that two ramp plates can be integrated to achieve weight saving and good portability of the ramp without deteriorating rigidity.

However, JP '287 fails to disclose improvement of weight saving although the ramp is configured to have a telescopic slide function to improve portability.

JP-U-3172583 discloses an ultra-lightweight portable ramp 100 provided with a main body side part 91 integrally molded with a derailment preventing bar 43 on both side faces and a central side face part 90 on which a hinge 42 is screwed by shortening a train side. The surface part 80 is broken and made in the two central-site surface parts 91 installed in the central part side by side, is symmetrical, is provided as a flat floor line considered as the inclined plane which passes a large-sized wheelchair, and integral forming, keeps an even-sheet interval and provides the board which supports a reverse part vertically to a reverse part as a reinforcement section. A nylon band 44 is fixedly provided at a 2 folding point at the side of the platform side of a central side part 90 of a body and a side part 91 at a center side, and a hooking metal 40 hooked on a door rail on a train side is fixed to the train side of the surface part 80. A large number of through holes are formed in a main body side part 90, a surface part 80, and a super-duralumin AL 2024 used for a flat floor surface fixed to a reinforcing part. According to such configuration, rigidity of the ramp can be improved by hollow segments.

However, JP '583 fails to disclose improvement of weight saving since integral molding is performed with duralumin material heavier than CFRP by welding. Further, since the main body is provided with wind through holes which might deteriorate material rigidity, it would be difficult to achieve both long product length and weight saving.

JP 2004-142509 A discloses a hatch cover of a ship provided with a beam connecting part to connect a beam to a top plate by arranging a beam at a predetermined interval on the lower surface of a top plate, wherein reinforcing ribs are arranged at a predetermined interval on an upper surface of a top plate, a rib welding part for welding and fixing a reinforcing rib to the top plate is provided, and the rib welding part is opposed to the beam connecting part with the top plate interposed therebetween. According to such configuration, bending strength and buckling strength of the hatch cover can be effectively enhanced by reinforcing hollow segments of bonded plates so that it is possible to cope with a sinking accident or the like of the ship.

However, the configuration disclosed in JP '509 cannot be applied to ramps because ribs are provided on a side opposite to the side where hollow segments are provided. It would be harmful to provide a protruding object on a surface on which wheelchairs or the like travel.

JP 2007-118758 A discloses a ramp for getting on/off trains, wherein a pair of platy members which are adjacent to each other arranged in a line and are coupled by a sheet member, at least the platy members positioned at both ends are equipped with projecting portions projecting out from first ends in a direction orthogonal to a coupling direction of the platy member, an end portion of the ramp on the projecting portion side has a notch portion, the ramp being foldable by bending the sheet member coupling the platy members. According to such configuration, portability of the ramp can be improved.

However, JP '758 fails to disclose reinforcement structure of the ramp and suggestion to achieve both long product length and weight saving.

JP 2016-067517 A discloses a portable ramp comprising at least a plate and a hollow segment, the hollow segment is extended in a longer direction of a ramp, a hollow part is formed between the plate and the hollow segment so that portability of the ramp is improved.

However, JP '517 fails to disclose reinforcement structure of the ramp and suggestion to achieve both long product length and weight saving.

JP-D-1527546 discloses a portable ramp to be placed over a step between objects in a building or a train, wherein a reinforcing section is provided on the bottom surface of the ramp in the longitudinal direction, the ramp being excellent in load bearing capacity and rigidity while it is lightweight with excellent portability. A wheelchair user can convey a ramp top at safety by installing a derailment protective barrier in the both side surfaces of a ramp. Since it comes to connect the ramp of two sheets, this article is foldable, and it can be developed and used at the time of use. The longitudinal direction both ends of the ramp are formed in tapered shape, respectively so that it may have a fixed inclination to make getting on and off of a wheelchair easy. According to such configuration, portability of the ramp can be improved.

However, JP '546 fails to disclose reinforcement structure of the ramp and suggestion to achieve both long product length and weight saving.

JP 2016-067518 A discloses a portable ramp used by being placed over a step for traveling a wheelchair, comprising a plate on which a wheelchair can run and which has a connection which makes the ramp divisible at least into two parts with a plane vertical to the plate so that portability of the is improved.

However, JP '518 fails to disclose reinforcement structure of the ramp and suggestion to achieve both long product length and weight saving.

It could therefore be helpful to provide a portable ramp to be placed over a step between objects which is light and has excellent portability, load bearing capacity and durability so that excellent safety is provided while ensuring rigidity when load is applied on the ramp when used by a wheelchair user, capable of corresponding to higher steps by being lengthened.

### SUMMARY

We thus provide:

(1) A ramp to be placed over a step or a gap between objects for wheelchairs to travel, comprising:

a plate member made of a carbon fiber-reinforced resin having a longitudinal elastic modulus in a bridging direction of 50 GPa or more;

a connecting section splittable into two members by a plane which is orthogonal to the plate member and is in parallel with the bridging direction;

a reinforcing section having a plurality of hollow segments disposed along the bridging direction; and a derailment preventing wall wherein

the hollow segments have a trapezoid-shaped cross section orthogonal to the bridging direction,

the trapezoid-shaped cross section having:

a height of 10 to 50 mm;

the trapezoid-shaped cross section having:

a base angle of a side contacting the plate member of 45° or more and less than 90°; and

a width of the side of 100 to 10 mm, and wherein

the derailment preventing wall is at least partially joined with a side end face of the plate member or a side end face of the hollow segments.

We improve the specific rigidity of the ramp used by a wheelchair user to get over steps in a building or steps between the ground and the doorway of vehicles such as automobile, train and bus against bending in the bridging direction by the hollow segment made of carbon fiber-reinforced resin having elastic modulus of 50 GPa or more in the bridging direction. Such an improved specific rigidity can achieve both weight saving up to 12 kg of ramp weight and long ramp length up to 3 m so that safety is ensured and burden is reduced for caregivers. For example, our lightweight ramp can be placed for wheelchairs to travel on by inclination angle of 14° or less over the height difference of 70 cm over which conventional short lightweight ramp cannot make wheelchairs get over because of steepness.

(2) The ramp according to (1), wherein a reinforcing member is detachably inserted into at least one of the hollow segments made of a fiber-reinforced resin containing a woven fiber and comprises at least one surface, and at least one surface of the reinforcing member contacts an upper base of the trapezoid-shaped cross section of the hollow segment while at least one surface of the reinforcing member contacts a lower base of the trapezoid-shaped cross section of the hollow segment.
(3) The ramp according to (2), wherein the reinforcing member is bonded to the upper or lower base.
(4) The ramp according to (2), wherein the reinforcing member is fastened to the upper or lower base.
(5) The ramp according to (2), wherein the reinforcing member is positioned by an external component part provided at a terminal of hollow segment.

We provide a portable ramp to be placed over a step between objects in a building or a train, which is light and has excellent portability, load bearing capacity and durability so that excellent safety is provided while ensuring rigidity when load is applied on the ramp when used by a wheelchair user, capable of corresponding to higher steps by being lengthened.

### DESCRIPTION OF THE DRAWINGS

FIG. 1 is a perspective view of an example of a portable ramp viewed obliquely from above.

FIG. 2 is a perspective view of an example of a portable ramp viewed obliquely from below.

FIG. 3 is a bottom view of a portable ramp.

FIG. 4 is A-A cross section view of the ramp shown in FIG. 3.

FIG. 5 is a cross section view of hollow segment into which a reinforcing part having an I-shape is inserted.

FIG. 6 is a cross section view of hollow segment into which a reinforcing part having an X beam-shape is inserted.

### EXPLANATION OF SYMBOLS

1: ramp
2,2a,2b: plate member
3: upper end of ramp
4: lower end of ramp
5: derailment preventing wall
6,6a,6b,6c: hollow segment
7: hollow part of hollow segment
8: length of lower base of hollow part of hollow segment
9: height of hollow part of hollow segment
10,11,12: reinforcing member
θ,θ2: base angle

### DETAILED DESCRIPTION

Hereinafter, our ramps will be explained sequentially. This disclosure is not limited to the following examples which are only representative.

Our ramps can be placed over a step or a gap between objects for wheelchairs or the like to travel, comprising: a plate member made of a carbon fiber-reinforced resin having a longitudinal elastic modulus in a bridging direction of 50 GPa or more; a connecting section splittable into two members by a plane which is orthogonal to the plate member and is in parallel with the bridging direction; a reinforcing section having a plurality of hollow segments disposed along the bridging direction; and a derailment preventing wall wherein the hollow segments have a trapezoid-shaped cross section orthogonal to the bridging direction, the trapezoid-shaped cross section having: a height of 10 to 50 mm; a base angle of a side contacting the plate member of 45° or more and less than 90°; and a width of the side of 100 to 10 mm, and wherein the derailment preventing wall is at least partially joined with a side end face of the plate member or a side end face of the hollow segments. It is preferable that the trapezoid-shaped cross section has the width of 90 to 70 mm and the height of 25 to 30 mm.

Our ramps improve specific rigidity used by a wheelchair user to get over steps in a building or steps between the ground and the doorway of vehicles such as automobile, train and bus against bending in the bridging direction by the hollow segment made of carbon fiber-reinforced resin having elastic modulus of 50 GPa or more in the bridging direction. Such an improved specific rigidity can achieve both weight saving up to 12 kg of ramp weight and long ramp length up to 3 m so that safety is ensured and burden is reduced for caregivers. For example, our lightweight ramp can be placed for wheelchairs to travel on by inclination angle of 14° (¼) or less over the height difference of 70 cm over which conventional short lightweight ramp cannot make wheelchairs get over because of steepness.

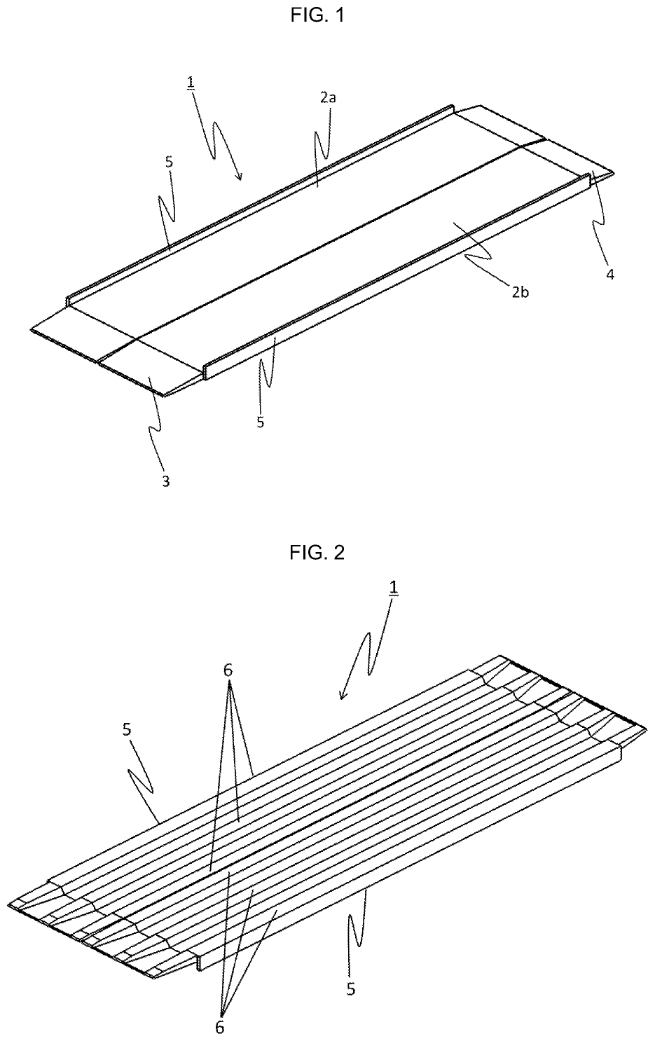

FIG. 1 shows a perspective view of an example of our ramps viewed obliquely from above. Symbol 1 indicates the ramp for wheelchairs to travel on while symbol 2 indicates plate member. Portable ramp 1 can be used as being placed over the gap between platform and train doorway. Upper end 3 of ramp 1 is placed on the train doorway while lower end 4 of ramp 1 is placed on the platform, for example. It is preferable that upper end 3 and lower end 4 of ramp 1 are tapered so that wheelchairs smoothly travel through the inclined ends. It is preferable that an antiskid rubber member is attached to a position to contact the doorway or the platform. It is preferable that upper end 3 and lower end 4 of ramp 1 are made of plastics because of light weight and cheap prices.

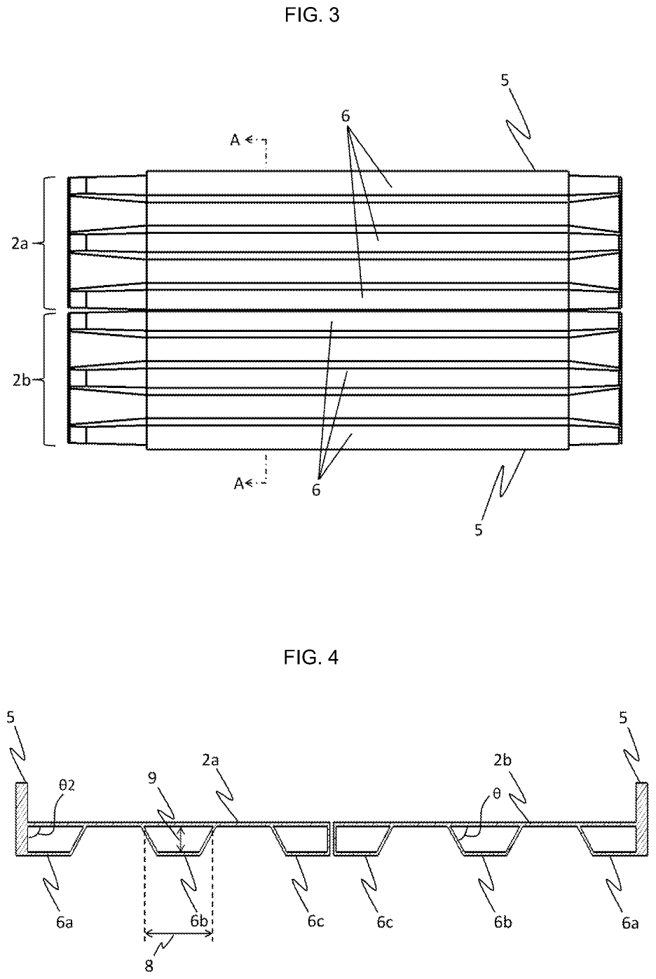

FIG. 2 shows a perspective view of an example of our ramps viewed obliquely from below while FIG. 3 shows a bottom view of our portable ramp. Symbol 5 indicates derailment preventing wall provided at both sides of ramp 1 while symbol 6 indicates hollow segment. Hollow segments 6 are provided as totally extending substantially along the longitudinal direction of plate member 1 in which moving bodies such as wheelchair travel. Such a long product structure extending between upper end 3 and lower end 4 can bear local load applied from tires of wheelchair or the like traveling on ramp 1.

FIG. 4 shows A-A cross section view of ramp 1 shown in FIG. 3. In FIG. 4, wheelchairs or the like travel on the top face of plate member 2. Symbols 6a,6b,6c indicate hollow segments, symbol 7 indicates hollow part of hollow segment and symbol 5 indicates derailment preventing wall.

When hollow segment 6 has a shape of trapezoid of which base angle is in a predetermined range, load bearing capacity against the load applied to plate member 2 on which a moving body travels can be improved. The base angle of less than 30° might have a shorter length of the hollow segment in the direction orthogonal to the plate member so that rigidity is insufficient. The base angle of more than 90° might have insufficient load bearing capacity. In FIG. 4, typical base angle θ of hollow segment 6b is shown.

The trapezoid is a kind of quadrangular in which at least one pair of sides opposite to each other are in parallel. It is preferable that the trapezoid is a regular trapezoid having a bottom side contacting plate member 2 longer than the top side. In FIG. 4, the top side is positioned under the bottom side contacting plate member 2. The load bearing capacity can be better with a structure where the bottom side is longer than the top side in the trapezoid having the top and bottom sides in parallel because such a shape of hollow segment can effectively suppress bending deformation of plate member when the load applied to the plate member is transmitted to the hollow segment.

In FIG. 4, hollow segment 6a has a shape of trapezoid having left base angle of 30° and right base angle of 60° while hollow segment 6c has a shape of trapezoid having left base angle of 30° and right base angle of 60°. Such symmetrical base angles of hollow segments 6a and 6c can achieve a uniform balance of receiving load.

It is preferable that one of the hollow segments is an isosceles trapezoid so that load is applied uniformly to the hollow segment from the moving body traveling on the top face of plate member 2 to achieve excellent load bearing capacity. Such an isosceles trapezoid can be realized by making the left and right base angles equal in hollow segment 6b shown in FIG. 4.

It is preferable that the hollow segments provided at an end of the plate member have a base angle of approximately 90° of which side face is provided in the same surface direction as the side end face of the plate member. It is preferable that at least one hollow segment is provided at an end of plate member 2. When one of the base angles of hollow segment is set to approximately 90°, strength of junction with derailment preventing wall 5 can be enhanced by increased number of junction sites.

In the cross section structural view shown in FIG. 4, hollow segments 6a are positioned at both ends of plate member 2. Hollow segments 6a have base angle θ2 of 90° at the outer side of end of plate member 2. Namely, hollow segments 6a having a side face orthogonal to plate member 2 are provided in the same surface direction as the side end face of plate member 2. Derailment preventing wall 5 is joined with both the side end face of plate member 2 and the side face of hollow segment 6a orthogonal to plate member 2.

It is preferable that ramp 1 is provided with derailment preventing wall 5 joined at least partially together with the side end face of plate member and the end face of hollow segment. It is more preferable that the derailment preventing wall is joined together with a whole surface of the side face of reinforcing part.

Such derailment preventing wall 5 provided at both right and left side faces of ramp 1 can prevent vehicles from falling off. Further, derailment preventing wall 5 can be carried easily and is hard to be broken even when a wheel runs thereon. When hollow segments 6a joined with derailment preventing wall 5 have a base angle of approximately 90° of which side face is provided in the same surface direction as the side end face of the plate member, the derailment preventing wall can be joined together with the side end face of the plate member in the plane orthogonal to the reinforcing part. When derailment preventing wall 5 is joined with both plate member 2 and hollow segment 6a by being joined together with the side end face of plate member 2 and the end face of hollow segment 6a, derailment preventing wall 5 can be improved in impact resistance against deformation and rupture.

It is preferable that derailment preventing wall 5 has a height of 15 to 30 mm projecting from the top face of plate member 2. It is not necessary that derailment preventing wall 5 extends over a total length of ramp 1. It is possible that derailment preventing wall 5 is not provided at upper end 3 or lower end 4. The “approximately 90°” allows flexibility of ±5° for convenience of design and production.

It is preferable that the hollow segment has a tangential direction angle of 30 to 90° at least at one tangential contact point to the plate member. It is more preferable that the tangential direction angle is 35 to 80°, preferably 45 to 60°.

From a viewpoint of weight saving, it is preferable that the ramp is made of a carbon fiber-reinforced plastic excellent in specific strength and specific rigidity. The reinforcing fiber may be a carbon fiber of polyacrylonitrile (PAN)-based, rayon-based, lignin-based or pitch-based, with or without surface treatment. The surface treatment may be performed with coupling agent, sizing agent, binding agent or additives. The above-described reinforcing fibers can be used solely or mixed by two or more kinds.

The fiber-reinforced plastic comprises reinforcing fiber and matrix resin, wherein the matrix resin may be a thermosetting resin such as epoxy resin, unsaturated polyester resin, vinylester resin, phenol (resol type) resin and polyimide resin, a polyester resin such as polyethylene terephthalate (PET) resin, polybutylene terephthalate (PBT) resin, poly trimethylene terephthalate (PTT) resin, polyethylene naphthalate (PEN resin) and liquid crystalline polyester resin, a polyolefin resin such as polyethylene (PE resin), polypropylene (PP resin) and polybutylene resin, a polyoxymethylene (POM) resin, a polyamide (PA) resin, a polyarylene sulfide resin such as polyphenylene sulfide (PPS) resin, a polyketone (PK) resin, a polyether ketone (PEK) resin, a polyetheretherketone (PEEK) resin, a polyether ketone (PEKK) resin, a polyether nitrile (PEN) resin, a fluorinated resin such as polytetrafluoroethylene resin, a crystalline resin such as liquid crystal polymer (LCP), a styrenic resin, an amorphous resin such as polycarbonate (PC) resin, polymethylmethacrylate (PMMA) resin, polyvinyl chloride (PVC) resin, polyphenylene ether (PPE) resin, polyimide (PI) resin, polyamide-imide (PAI) resin, polyetherimide (PEI) resin, polysulfone (PSU) resin, polyethersulfone resin and polyarylate (PAR) resin, a thermoplastic elastomer of phenol-based, phenoxy-based, polystyrene-based, polyolefin-based, polyurethane-based, polyester-based, polyamide-based, polybutadiene-based, polyisoprene-based or acrylonitrile-based, or a copolymer or modification thereof. Above all, it is preferably the epoxy resin or the vinylester resin from viewpoints of adhesion to carbon fibers, mechanical properties of shaped product and formability.

It is preferable that the fiber-reinforced resin of carbon fiber has a weight fiber content of 15 to 80 wt %. The content of less than 15 wt % might have insufficient load bearing capacity and rigidity so that a predetermined target function is not achieved. The weight content of more than 80 wt % might have voids to make a forming process have problems.

It is preferable that the fiber-reinforced plastic constituting the plate member or the hollow segments comprises continuous carbon fibers. The reinforcing fibers may be disposed in parallel with the longitudinal direction of the bridging direction of the ramp or disposed substantially orthogonal to the longitudinal direction. These disposition patterns can be combined to improve bending strength and surface pressure resistance as a whole ramp.

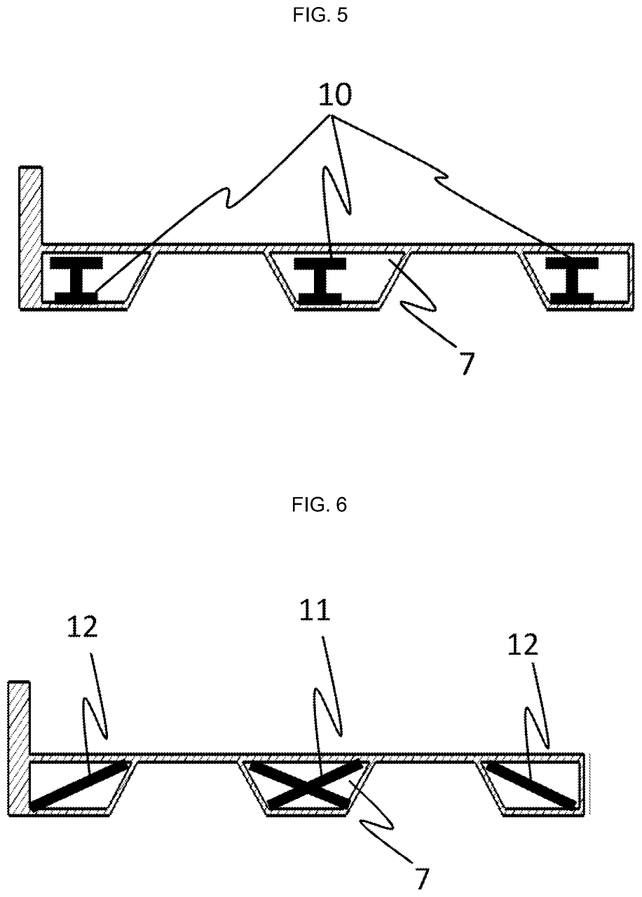

FIG. 5 shows a cross section view in which reinforcing member 10 detachably inserted into hollow part 7 of hollow segment 6 of ramp 1 comprises at least one surface of fiber-reinforced resin containing woven fiber. At least one surface of reinforcing member 10 contacts the upper base of trapezoid-shaped cross section of the hollow segment while at least one surface of reinforcing member 10 contacts the lower base of trapezoid-shaped cross section of the hollow segment. Reinforcing member 10 has such an H-shaped reinforcing structure shown in FIG. 5.

When ramp 1 is made longer deformation such as buckling and torsion might be caused other than a bending deformation. We improve resistance against the buckling or torsion caused in plate materials constituting the plate member of the ramp and hollow segment 6 so that excessive deformation mode is suppressed while the ramp length can be increased to 3 m or more. Then our ramp can be used for a step having a height difference of 70 cm or more which cannot be got over by wheelchairs with a conventional short lightweight ramp because of steep inclination. Because even local deformation can be suppressed usability and comfort are improved.

It is preferable that the reinforcing member is made of a material structurally having a shear resistance so that buckling deformation and shear deformation of the ramp body are suppressed. From a viewpoint of weight saving, it is preferable that the reinforcing member is made of carbon fiber-reinforced plastic excellent in specific strength and specific rigidity. The reinforcing fiber may be a carbon fiber of polyacrylonitrile (PAN)-based, rayon-based, lignin-based or pitch-based, with or without surface treatment thereon. The surface treatment may be performed with coupling agent, sizing agent, binding agent or additives. The above-described reinforcing fibers can be used solely or mixed by two or more kinds. It is preferable that the reinforcing fiber is reinforced and oriented in two or more directions. It is preferable that the reinforcing member has an in-plane shear elastic modulus of 3,000 MPa or more.

It is preferable that the reinforcing member has a shape capable of suppressing deformation of trapezoid-shaped cross section orthogonal to the extending direction of hollow segment. It is preferable that the shape capable of suppressing shear deformation is X-beam shape connecting the four vertexes of trapezoid-shaped cross section of reinforcing member 11 shown in FIG. 6 or I-beam shape connecting the two vertexes of trapezoid-shaped cross section of reinforcing member 12 shown in FIG. 6. For suppressing the in-plane buckling of hollow segment, it is preferable that the shape is H-shape connecting the top side and the bottom side of trapezoid of reinforcing member 10 shown in FIG. 5.

It is preferable that the reinforcing member inserted into the hollow segment is integrated by bonding so that reinforcement is improved.

It is preferable that the reinforcing member inserted into the hollow segment is integrated by mechanically fastening so that reinforcement is improved.

It is possible that the reinforcing member inserted into the hollow segment is positioned by an external component part provided at the terminal of hollow segment so that vibration is absorbed by friction loss on the contact surface between the hollow segment and the reinforcing member to improve stability in traveling on the ramp.

### INDUSTRIAL APPLICATION

Our ramps are industrially available as ramps to be placed over a step between objects for wheelchairs to travel thereon.

1-5. (canceled)

6. A ramp to be placed over a step or a gap between objects for wheelchairs to travel, comprising:
a plate member made of a carbon fiber-reinforced resin having a longitudinal elastic modulus in a bridging direction of 50 GPa or more;
a connecting section splittable into two members by a plane which is orthogonal to the plate member and is in parallel with the bridging direction;
a reinforcing section having a plurality of hollow segments disposed along the bridging direction; and
a derailment preventing wall wherein
the hollow segments have a trapezoid-shaped cross section orthogonal to the bridging direction,
the trapezoid-shaped cross section having:
a height of 10 to 50 mm;
a base angle of a side contacting the plate member of 45° or more and less than 90°; and
a width of the side of 100 to 10 mm, and wherein
the derailment preventing wall is at least partially joined with a side end face of the plate member or a side end face of the hollow segments.

7. The ramp according to claim 6, wherein a reinforcing member is detachably inserted into at least one of the hollow segments made of a fiber-reinforced resin containing a woven fiber and comprises at least one surface, and at least one surface of the reinforcing member contacts an upper base of the trapezoid-shaped cross section of the hollow segment while at least one surface of the reinforcing member contacts a lower base of the trapezoid-shaped cross section of the hollow segment.

8. The ramp according to claim 7, wherein the reinforcing member is bonded to the upper or lower base.

9. The ramp according to claim 7, wherein the reinforcing member is fastened to the upper or lower base.

10. The ramp according to claim 7, wherein the reinforcing member is positioned by an external component part provided at a terminal of hollow segment.
